(19) United States
(12) Patent Application Publication
(10) Pub. No.: US 2003/0123841 A1
(43) Pub. Date: Jul. 3, 2003

(54) Commercial detection in audio-visual content based on scene change distances on separator boundaries

(76) Inventor: Sylvie Jeannin, Paris (FR)

Correspondence Address: PHILIPS ELECTRONICS NORTH AMERICAN CORP, 580 WHITE PLAINS RD, TARRYTOWN, NY, 10591, US

(21) Appl. No.: 10/029,812

(22) Filed: Dec. 27, 2001

(51) Int. Cl. H04N 5/76; H04B 1/20

(52) U.S. Cl. 386/46; 358/908

(57) ABSTRACT

A method and device for detecting commercials using the encoding parameters of a compressed video stream is provided. A video encoder receives uncompressed video data and generates a compressed video data. A plurality of separators, each defined by at least two consecutive scene changes in a sequence of the compressed video data, is detected. Then, the beginning and ending of a commercial break is derived by comparing the gap between these separators to a predetermined threshold value.

### BACKGROUND OF THE INVENTION

1. Field of the Invention

The invention relates to the detection of a particular content in a stream of video data signals, and more particularly to the accurate detection of the boundaries of commercial contents.

2. Description of the Invention

Both ReplayTV (trademark of REPLAY NETWORKS, INC., of Palo Alto, Calif.) and TiVo (trademark of TIVO, Inc., of Sunnyvale, Calif.) are the first wave of a new type of “VCR” that gives the television viewer new abilities to capture and manipulate the stream of television shows, which flow from their cable and satellite systems. These personal television devices act as a personal assistant by changing channels for viewers, recording programs that interest the viewers, and assisting the viewers to watch recorded programs without commercials when they wish.

There are known methods for detecting commercials. One method is the detection of a black frame (or monochrome frame) coupled with silence, which may indicate the beginning of a commercial break. When the signal is in digital format, black frames are detected based on the sum of the absolute differences of DC coefficients of consecutive blocks but are detected on I-frames only. This has a drawback in that if the video data is represented by video sequences with a long group of pictures (GOP), the higher the probability that black frames are not intra encoded and thus not detected. Moreover, the black frame detection worked perfectly on some content but performed very badly after it was copied and edited. This was caused by the noise introduced by the copy-paste process. It is thus likely that in case of bad transmission (bad reception, bad weather), the black frame detection will perform poorly. Furthermore, the problem with commercial detection that relies on black frames is that broadcasters wanting to avoid commercial skipping could easily replace black frame separators by something else. In France and the Netherlands at least, some channels have already replaced black frames by blue frames, or by white frames. Another known indicator of commercials is high activity, stemming from the observation or assumption that objects move faster and change more frequently during commercials than during the features being broadcast.

However, the above prior art methods face many difficulties in identifying the precise point of the beginning and ending of a commercial. Black frames produce false positives as any sequence of black frames followed by a high action sequence can be misjudged and skipped as a commercial. Accordingly, there exists a need to provide an improved method and system of detecting the start and end of commercials.

### SUMMARY OF THE INVENTION

The present invention relates to a method and apparatus for detecting commercial breaks so that the detected commercials can be skipped during a replay mode.

According to an aspect of the invention, the method for detecting commercials in a compressed video stream includes the steps of: compressing video data and generating compressed video data; detecting a plurality of separators based on the generated compressed data, each of the separators is defined by at least two consecutive scene changes; determining the beginning and ending of a commercial break among the plurality of separators by comparing a gap between the plurality of separators. The method further comprising the step of identifying one of the separators as the potential ending of a commercial break when the gap between the one separator and a previous separator is less than the predetermined threshold value. The step of determining the beginning and ending of a commercial break further comprises the steps of: identifying one of the separators as the beginning of a commercial break when the gap between the one separator and a previous separator is greater than a predetermined threshold value. The step of detecting the plurality of separators in the compressed video data includes identifying an abrupt increase in the average Mean Absolute Difference (MAD) value of the generated compressed data.

According to another aspect of the invention, the method for detecting commercials in a compressed video stream includes the steps of: encoding incoming video data received from a transmitting source to generate compressed video data; detecting a plurality of separators in the compressed video data, each of the plurality of separators including at least two consecutive scene changes according to the compressed video data;

determining the beginning and ending of a commercial break by comparing a gap between the plurality of separators to a predetermined threshold value; identifying one of the separators as the beginning of a commercial break when the gap between the one separator and a previous separator is greater than a predetermined threshold value; and, identifying one of the separators as the ending of a commercial break when the gap between the one separator and a previous separator is less than the predetermined threshold value, wherein the plurality of separators is selectively inserted into the video data at the transmitting source.

According to a further aspect of the invention, the apparatus for detecting commercials in a compressed video stream includes: a video encoder for receiving uncompressed video data and generating compressed video data; a detector for detecting a plurality of separators in the compressed video data; a processor configured to edit the compressed video data by identifying the beginning and ending of a commercial break in the compressed video data; a playback selector for editing the compression video data to skip the commercial break for a subsequent viewing; a memory for storing the compressed video data with the identification of the beginning and ending of the commercial break; and, a decoder for generating decompressed video data, wherein the detector is programmed to identify an indicator of at least two scene cuts in the uncompressed video data and to generate an identifier of the location in a sequence of the compressed video data coinciding with the indicator of at least two the scene cuts. The compressed video data includes an identifier of a presence of a sequence of uni-color frames; an identifier of a transition between a television program and the commercial break; an identifier of a transition between the successive commercial programs, and an identifier of at least two successive scene cuts. The compressed video data further includes at least one of a quantizer scale, motion vector data, bit rate data, a variation of luminance within a frame, a variation of color within a frame, a total luminance of a frame, a total color of a frame, change in luminance between frames, a mean absolute difference, and a quantizer scale.

These and other advantages will become apparent to those skilled in this art upon reading the following detailed description in conjunction with the accompanying drawings.

### BRIEF DESCRIPTION OF THE DRAWINGS

FIG. 1 shows a block diagram of a hardware system whereto the embodiment of the present invention may be applied;

FIG. 2 illustrates a simplified block diagram of the system according to an embodiment of the present invention;

FIG. 3 illustrates the format of a series of video frames during the encoding process in accordance with the present invention; and,

FIG. 4 is a flow chart illustrating the operation process according to an embodiment of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

To facilitate an understanding of this invention, background information relating to the Motion Pictures Expert Group (MPEG2) coding will be described. In MPEG-2, video data are represented by video sequences, each including of a group of pictures (GOP), each GOP including pieces of data that describe the pictures or “frames” that make up the video. Each picture is divided into a plurality of slices, and each slice consists of a plurality of macro-blocks disposed in a line from left to right and from top to bottom. Each of the macro-blocks consists of six components: four brightness components Y1 through Y4 representative of the brightness of four 8×8 pixel blocks constituting the macro-block of 16×16 pixels, and two colors (U, V) constituting difference components Cb and Cr of 8×8 pixel blocks for the same macro-block. Lastly, a block of 8×8 pixels is a minimum unit in video coding.

The MPEG2 coding is performed on an image by dividing the image into macro-blocks of 16×16 pixels, each with a separate quantizer scale value associated therewith. The macro-blocks are further divided into individual blocks of 8×8 pixels. Each 8×8 pixel block of the macro-blocks is subjected to a discrete cosine transform (DCT) to generate DCT coefficients for each of the 64 frequency bands therein. The DCT coefficients in an 8×8 pixel block are then divided by a corresponding coding parameter, i.e., a quantization weight. The quantization weights for a given 8×8 pixel block are expressed in terms of an 8×8 quantization matrix. Thereafter, additional calculations are affected on the DCT coefficients to take into account, namely the quantizer scale value, among other things, and thereby completing the MPEG2 coding. It should be noted that other coding techniques, such as JPEG or the like, can be used in the present invention.

In MPEG codes, the codes are divided into three types: (1) the intra-frame encoded codes defining an intra-coded picture as an I picture; (2) the inter-frame encoded codes that are predicted only from a preceding frame to constitute a predictive coded picture as a P picture; and, (3) the inter-frame encoded codes that are predicted from preceding and succeeding frames to constitute a bi-directionally predictive coded picture as a B picture. The I frame, or an actual video reference frame, is periodically coded, i.e., one reference frame for each of the fifteen frames. A prediction is made of the composition of a video frame, the P frame, to be located in a specific number of frames forward and before the next reference frame. The B frame is predicted between the I frame and P frame, or by interpolating (averaging) a macroblock in the past reference frame with a macroblock in the future reference frame. The motion vector is also encoded, which specifies the relative position of a macroblock within a reference frame with respect to the macroblock within the current frame.

As described above, any video data following the international standard MPEG code can recover the image from MPEG codes. During the encoding process, the present invention provides a mechanism for detecting commercial breaks from a stream of video information.

Now, a description will be made in detail in regards to this invention with reference to the drawings.

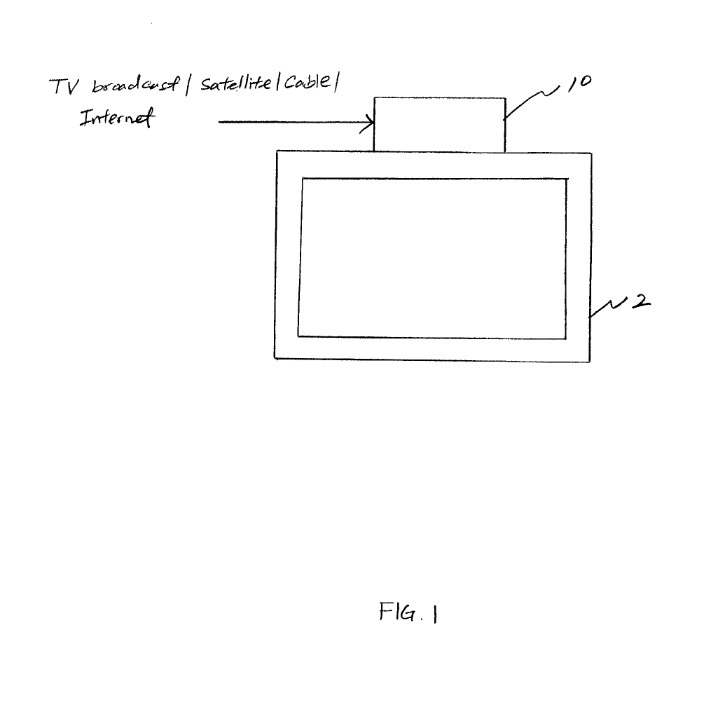

FIG. 1 shows a block diagram of a hardware system whereto the embodiment of the present invention may be applied. As shown in FIG. 1, the inventive detection system 10 is adapted to receive a stream of video signals from a variety of sources, including a cable service provider, a digital high definition television (HDTV) and/or digital standard definition television (SDTV) signals, a satellite dish, a conventional RF broadcast, an Internet connection, or another storage device, such as a VHS player or DVD player. The audio/video programming along with the data signals can be delivered in analog, digital, or digitally compressed formats via any transmission means, including satellite, cable, wire, television broadcast, or sent via the Web. The Internet connection can be via a high-speed line, RF, conventional modem or by way of a two-way cable carrying the video programming. It should be noted that the present system is capable of being connected to other possible networks, such as a direct private network and a wireless network.

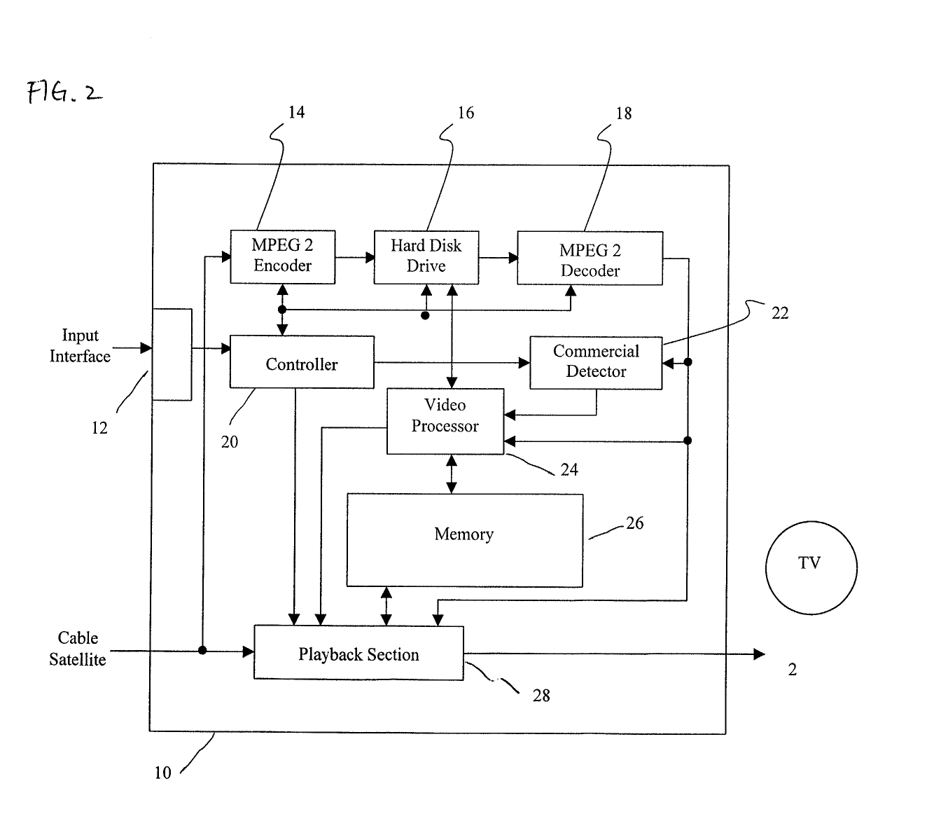

FIG. 2 illustrates an exemplary detection system 10 in greater detail according to the embodiment of the present invention. The detection system 10 includes an input interface (i.e., IR sensor) 12, an MPEG-2 encoder 14, a hard disk drive 16, an MPEG-2 decoder 18, a controller 20, a commercial detector 22, a video processor 24, a memory 26, and a playback section 28. It should be noted that an MPEG encoder/decoder can comply with other MPEG standards, i.e., MPEG-1, MPEG-2, MPEG-4, and MPEG-7. The controller 20 oversees the overall operation of the detection system 10, including a detection mode, record mode, play mode, and other modes that are common in a video recorder/player.

During a normal viewing mode, the controller 20 causes the incoming television signals to be demodulated and processed by the video processor 24 and transmits them to the television set 2. The video processor 24 converts the incoming TV signals to corresponding baseband television signals suitable for display on the television set 2. Here, the incoming TV signals are not stored or retrieved from the hard disk driver 16.

During a normal recording mode, the controller 20 causes the MPEG-2 encoder 14 to receive incoming television signals delivered from satellite, cable, wire, and television broadcasts, or the web, and converts the received TV signals to the MPEG format for storage on the hard disk driver 16. Thereafter, the controller 20 causes the hard disk driver 16 to stream the stored television signals to the MPEG-2 decoder, which in turn transmits the decoded TV signals to be transmitted to the television set 2 via the play back section 28 during a normal playing mode. At the same time, the commercial detector 22 detects the beginning and ending of commercial breaks using encoding parameters (explained later). Then, the video processor 24 processes a stream of video signals, including a plurality of commercials, and stores them in the memory 26 without the commercial content for subsequent retrieval. Alternatively, the video processor 24 can mark the beginning and ending of a commercial break, so that these marked commercial segments can be skipped at a later stage. Finally, upon receiving a request to replay the recorded program without commercials, the program content stored in the memory 26 are forwarded to the television set 2 for display via the play back section 28.

The provision of detecting the beginning and ending of commercials from a stream of video information is explained in greater detail below.

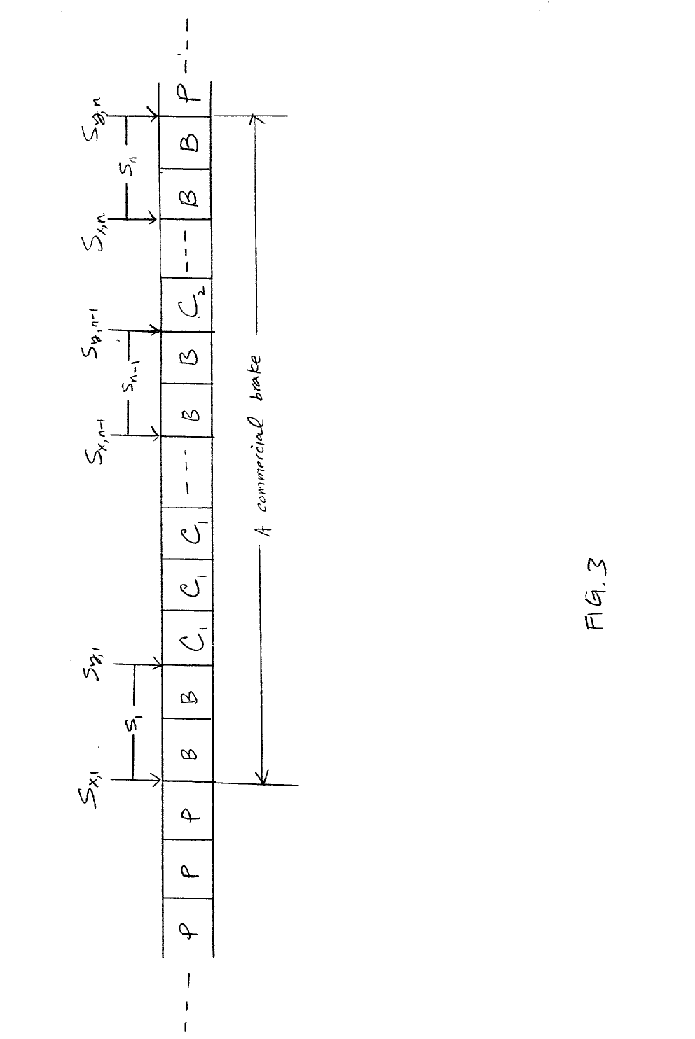

Referring to FIG. 3, at the broadcasting end, a separator, defined by black frames (BF) or other unicolor frames, is generally used to separate between a program (Pr) and an adjacent commercial or between successive commercials (Cᵢ). As such, the present invention relies on this fact that there are a few of these frames always used for the purpose of separating a commercial from its surrounding content, and in particular between both (1) successive commercials within a commercial break, (2) between the end (or interruption) of a program and the beginning of a commercial break, and (3) between the end of a commercial break and the beginning (or continuation) of a program. Thus, the present invention utilizes the encoding parameters, rather than the intrinsic characteristics of commercial content, to detect commercial breaks. In addition to detecting commercial breaks based on the frames used to “fill the editing gaps” between successive contents at the broadcast end, the present invention incorporates the separators, Sₙ, which can be characterized as two scene cuts (hereinafter referred to as “back-to-back scene cuts”, S_{x,n} and S_{y,n}″) that are very close to each other, as shown in FIG. 3. The scene change detection according to the present invention works on each of I, P, and B frames, which is not the case in the prior art black frame detection methods. The prior art uses the detection of black frames on I-frames only. Hence, the detection of “back-to-back scene cuts” according to the present invention should be small (i.e., 3 to 4 frames) enough to detect small separators that may not contain any I-frame.

For the MPEG-2 encoding, any number of commercially or publicly available integrated circuit (IC) can be utilized in various implementations in accordance with the preferred embodiment of the present invention. On these IC's, dedicated encoding hardware blocks generate and deliver in real-time internal calculation parameters (hereinafter referred to as “low-level features”) of the MPEG-2 encoding process. Examples of “low-level features” are the coding mode of each frame (I, P, B), a quantizer scale, motion vector data, bit rate data, a variation of luminance within a frame, a variation of color within a frame, a total luminance of a frame, a total color of a frame, change in luminance between frames, a mean absolute difference, and a quantizer scale. These “low-level features” are then processed to obtain “mid-level features” that can be used for commercial detection in accordance with the present invention. To this end, the commercial detector 22 generates the location of commercial breaks based on some “mid-level features,” such that these locations are stored to skip commercials at viewing time.

Accordingly, the present invention uses the “the low-level features” at each frame to extract the corresponding “mid-level features” as follows:

(1) Pict_Cod_Type (the picture coding type, Intra or Inter);

(2) Lum_DC_diff (the sum of absolute differences of DC coefficients for adjacent blocks); and,

(3) MAD_total_UP (the sum of Mean Absolute Difference (MAD), which represents the sum of the mean absolute differences between each block of the original frame to encode and its corresponding motion predicted block (the sum is done only on the top of the image to avoid prediction errors due to subtitles changes, or other written/graphics informations appearing usually at the bottom of the screen).

Accordingly, the present invention first detects the very close consecutive scene changes or “back-to-back scene cuts” between the successive commercials within a commercial break as well as at the transitions between programs and commercial breaks. To this end, any scene change detection method known in this art may be used in accordance with the techniques of the present invention. For example, a sudden change in scene content due to an abrupt change in the average MAD value may be used as an indication to detect the “back-to-back scene cuts.” As explained earlier, the MAD represents the motion prediction error. Note that MAD correspond to the motion prediction error: if the error is big, it indicates that the image to encode could not be predicted using motion prediction from a previous frame, and a scene cut occurred.

That is, part of the MPEG encoding process is the estimation of the motion of fields of luminance from one frame to another. The results of this process are displacement vectors that are use to predict the actual frame to encode. The error between the prediction and the actual frame is expressed using MAD values. At a sharp scene change nearly no good matching macroblocks will be found. Thus, the MAD value at a sharp scene change is much higher than the average MAD value.

If two such consecutive scene changes are detected as described above, then they can be considered as a separator (1) between successive commercials within a commercial break, or (2) between programs and adjacent commercial break. Thereafter, an algorithm for detecting the beginning and ending of a commercial break can be applied to obtain the exact boundaries of the commercial break as described below.

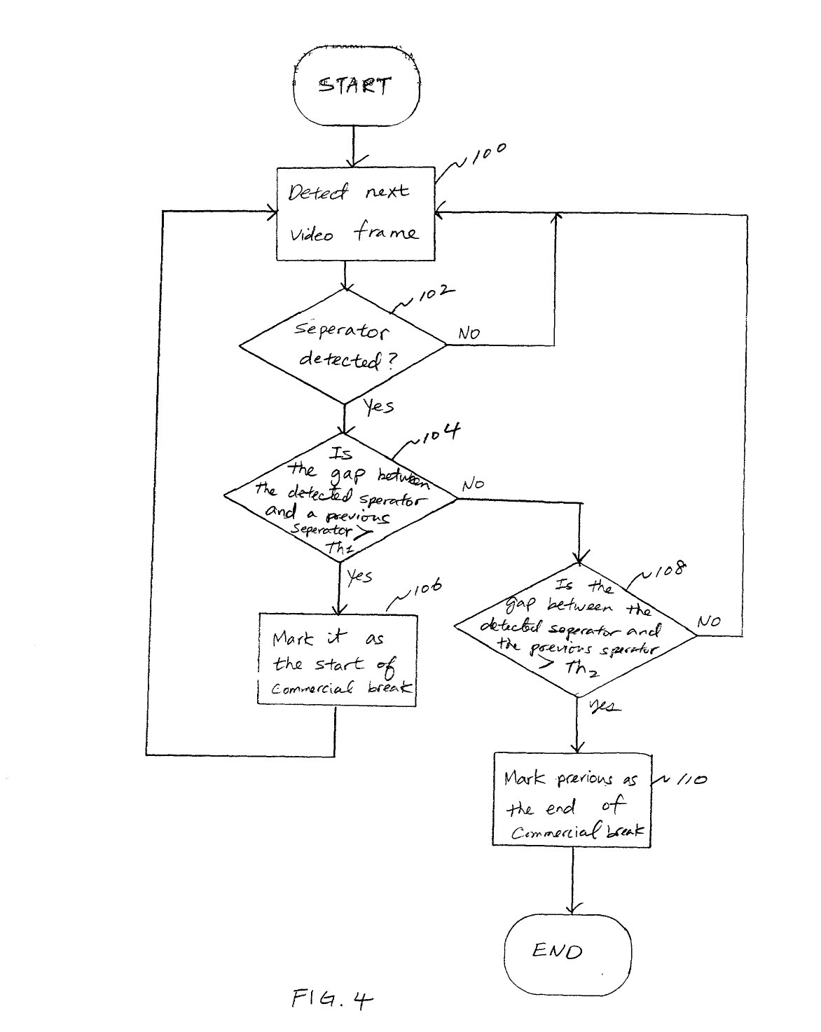

FIG. 4 is a flow chart illustrating the operation steps for detecting commercial breaks using the separator configuration shown in FIG. 3. It will be appreciated by those of ordinary skill in the art that unless otherwise indicated herein, the particular sequence of steps described is illustrative only and can be varied without departing from the spirit of the invention. In addition, the flow diagrams illustrate the functional information that one of ordinary skill in the art requires to fabricate circuits or to generate computer software to perform the processing required of the particular apparatus.

In step 110, each of the video frames being encoded is analyzed to detect the beginning and ending of a commercial break. In step 102, it is determined whether a separator or a “back-to-back scene cuts” is detected. If the separator is not detected, the next frame is analyzed for a separator. If a separator is detected, it is verified that the detected separator is not preceded by another separator, and that the detected separator is the first in a series of “separators in succession.” A separator is considered to be in succession from the previous one if they are closer than a specified number of frames apart (typically closer than 50 seconds apart for a GOP of 6). Thus, to ensure that the detected separator is not a middle separator in the same commercial break, it is determined whether the frame gap between the detected separator and a previously detected separator is greater than a first predetermined threshold value in step 104. As the separator defined by the black or other unicolor frames can occur only between commercial breaks, which is much shorter than the length of a particular program segment, the threshold value is used to distinguish the first separator in a series of “separators in succession.” If so, the detected separator is marked as the start of a commercial break in step 106. Thereafter, the next frame is analyzed again.

Similarly, if the frame gap between the detected separator and a previously detected separator is less than the first predetermined threshold in step 104, it is determined whether the detected separator is the end of a commercial break in step 108. It is noted that after detecting the beginning of the commercial, each new separator will be marked as the potential commercial break's end, from which only the last one should be kept. To determine the ending of a commercial break, it is determined whether the frame gap between the detected separator and a previously detected separator is greater than a second predetermined threshold value in step 108. If so, the previously detected separator is marked as the ending of a commercial break in step 110.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

We claim:

1. A method for detecting commercials in a compressed video stream, the method comprising the steps of:
compressing video data and generating compressed video data;
detecting a plurality of separators based on said generated compressed data, each of said separators is defined by at least two consecutive scene changes;
determining the beginning and ending of a commercial break among said plurality of separators by comparing a gap between said plurality of separators.

2. The method of claim 1, wherein the step of determining the beginning and ending of a commercial break further comprises the steps of:
identifying one of said separators as the beginning of a commercial break when the gap between said one separator and a previous separator is greater than a predetermined threshold value.

3. The method of claim 2, further comprising the step of identifying one of said separators as the ending of a commercial break when the gap between said one separator and a next separator is greater than said predetermined threshold value. (no: when the gap between the separator and the next one is greater that a predetermined threshold)

4. The method of claim 1, wherein said plurality of separators is inserted into said video data at a transmitting source.

5. The method of claim 1, wherein the step of detecting said plurality of separators in said compressed video data includes identifying an abrupt increase in an average Mean Absolute Difference (MAD) value of said generated compressed data.

6. The method of claim 1, wherein the step of detecting said plurality of separators in said compressed video data is performed based on an increasein an average Mean Absolute Difference (MAD) value of said generated compressed data.

7. A method for detecting commercials in a compressed video stream, the method comprising the steps of:
encoding incoming video data received from a transmitting source to generate compressed video data;
detecting a plurality of separators in said compressed video data, each of said plurality of separators including at least two consecutive scene changes according to said compressed video data;
determining the beginning and ending of a commercial break by comparing a gap between said plurality of separators to a predetermined threshold value;
identifying one of said separators as the beginning of a commercial break when the gap between said one separator and a previous separator is greater than said predetermined threshold value; and,
identifying one of said separators as the ending of a commercial break when the gap between said one separator and a next separator is greater than said predetermined threshold value.

8. The method of claim 7, wherein said plurality of separators is selectively inserted into said video data at said transmitting source.

9. The method of claim 7, wherein the step of detecting said plurality of separators in said compressed video data is performed based on a change in an average Mean Absolute Difference (MAD) value of said generated compressed data.

10. An apparatus for detecting commercials in a compressed video stream, comprising:
a video encoder for receiving uncompressed video data and generating compressed video data;
a detector for detecting a plurality of separators in said compressed video data;
a processor configured to edit said compressed video data by identifying the beginning and ending of a commercial break in said compressed video data; and,
a playback selector for editing said compression video data to skip said commercial break for a subsequent viewing.

11. The apparatus of claim 10, further comprising a memory for storing said compressed video data with the identification of the beginning and ending of said commercial break.

12. The apparatus of claim 10, further comprising a decoder for generating decompressed video data.

13. The apparatus of claim 10, wherein said compressed video data includes an identifier of a presence of a sequence of uni-color frames.

14. The apparatus of claim 10, wherein said compressed video data includes an identifier of a transition between a television program and said commercial break.

15. The apparatus of claim 10, wherein said compressed video data includes an identifier of a transition between the successive commercial programs.

16. The apparatus of claim 10, wherein said compressed video data includes an identifier of at least two successive scene cuts.

17. The apparatus of claim 10, wherein said detector detects said plurality of separators based on an abrupt change in an average Mean Absolute Difference (MAD) value of said generated compressed data.

18. The apparatus of claim 10, wherein said compressed video data includes at least one of a quantizer scale, motion vector data, bit rate data, a variation of luminance within a frame, a variation of color within a frame, a total luminance of a frame, a total color of a frame, change in luminance between frames, a mean absolute difference, and a quantizer scale.

19. The apparatus of claim 10, wherein said processor is programmed to identify an indicator of at least two scene cuts in said uncompressed video data and to generate an identifier of the location in a sequence of said compressed video data coinciding with said indicator of at least two said scene cuts.
